(19) United States
(12) Patent Application Publication
(10) Pub. No.: US 2016/0021089 A1
(43) Pub. Date: Jan. 21, 2016

(54) CONTENT DELIVERY SUBSCRIPTION

(71) Applicant: Dropbox, Inc., San Francisco, CA (US)

(72) Inventors: John ADAMS, San Francisco, CA (US); Aditi JAIN, San Francisco, CA (US); Matteus PAN, San Francisco, CA (US)

(21) Appl. No.: 14/331,801

(22) Filed: Jul. 15, 2014

(51) Int. Cl. H04L 29/06; H04L 29/08

(52) U.S. Cl. CPC H04L 63/083; H04L 67/10; H04L 67/26

(57) ABSTRACT

Various embodiments of the present technology involve a synchronized content management system (CMS) automatically receiving and storing content items associated with a digital content subscription in a single location. For example, the CMS can establish and maintain a persistent relationship with various service providers that enable the service providers to push content items to a respective user account at the CMS. The persistent relationship can, in one example, be a one-way relationship established using a security token to prevent a service provider from accessing other content items store in the user's account.

### TECHNICAL FIELD

The present technology pertains to content delivery, and more specifically pertains to enabling a third-party to automatically delivery content to a user via a content management system.

### BACKGROUND

Users can subscribe to automatically receive content items, such as pictures from friends, electronic books and magazines, news, videos, songs, documents, podcasts, lectures, etc., on their computing device. Each of these content items, however, tends to be associated with a different application which stores a respective content item whose corresponding application needs to be accessed in order to be consumed. For example, a user periodically receiving electronic magazines and audio lectures, for example, must open two different applications in order to locate and consume each content item.

Additionally, many users receive such content items on their mobile devices where storage space is a limited. Since many users do not actively monitor fluctuations in their device storage and nor are users typically in the habit of deleting content items after a respective content item has been consumed, their device storage can quickly fill up without them being aware. In some instances, content items can include settings where, after a set period of time the content item is removed from the user's device. This, however, is not necessarily an ideal solution since some users may want to refer back and, therefore, save a respective content for repeat consumption. Accordingly, it may be advantageous to develop a means of enabling users to automatically receive subscription content from a variety of different applications or sources in a single location accessible by, but remotely stored from, their computing device.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for automatically receiving and storing content items associated with a digital content subscription in a single location accessible by a computing device without taking up unnecessary space on the computing device. In at least one embodiment, a content management system (CMS) can receive a request to establish a persistent one-way content delivery pipeline (pipeline) with a third-party service provider. The pipeline enabling the service provider to deliver content items to a user account at the CMS on a reoccurring basis, such a subscription. Accordingly, the CMS can generate a token that, when provided to the service provider, enables the service provider to push content to a folder associated with the user account.

In at least one embodiment, the request could be received through an application programming interface (API) on a webpage of a service provider. Accordingly, while subscribing to receive content from the service provider, the user could be prompted for login credentials to their user account with the CMS. In this example, the login credentials could be included in the request to establish the pipeline. For example, when a user signs into an online account with their bank, there could be multiple delivery options for them to receive their monthly bank statements. Instead of having their statements mailed or emailed to them, the user could select to have their statements automatically delivered to a designated folder in their user account at the CMS. Accordingly, since the CMS is an online synchronized storage system, the designated folder can be synchronized across each of the user's devices, enabling the user to conveniently access their bank statements from any of their devices. This can be extended to any type of media for which a persistent relationship exists, such as digital magazines, audio lectures, books, reoccurring service invoices, and the like.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A shows an example screenshot wherein a user selects a content management system to automatically receive and store content items periodically delivered by a third-party service provider in accordance with various embodiments;

FIG. 1B shows another example screenshot wherein the user logs into their account with the content management system to enable automatic content item delivery in accordance with various embodiments;

FIG. 1C shows another example screenshot wherein the third-party service provider displays a confirmation message acknowledging future delivery of the content items to the content management system in accordance with various embodiments;

FIG. 2 shows an environment wherein the third-party service provider sends a content item to computing devices associated with the user though the content management system in accordance with various embodiments;

FIG. 3 shows another environment wherein multiple third-party service providers send content items to the computing devices associated with the user though the content management system in accordance with various embodiments;

FIG. 4 shows an exemplary process wherein a content management system is selected to receive subscription content for a user in accordance with at least one embodiment;

FIG. 5 shows another exemplary process wherein a content management system is selected to receive subscription content for a user in accordance with at least one embodiment;

FIG. 6 shows an exemplary configuration of devices and a network in accordance with the invention;

FIG. 7A shows a conventional system bus computing system architecture; and

FIG. 7B shows a computer system having a chipset architecture.

### DESCRIPTION

Various embodiments of the disclosure are discussed in detail below. While specific implementations are discussed, it should be understood that this is done for illustration purposes only. A person skilled in the art will recognize that other components and configurations may be used without departing from the spirit and scope of the disclosure.

The disclosed technology addresses the need in the art for automatically receiving and storing content items associated with a digital content subscription in a single location accessible by a computing device without taking up unnecessary space on the computing device. As discussed herein, a synchronized content management system (CMS) can automatically receive and store content items associated with a digital content subscription for a user. For example, the CMS can establish and maintain a persistent relationship with various service providers that enables the service providers to push content items, such as digital magazines, audio lectures, books, reoccurring service invoices, and the like, to a respective user account at the CMS. This relationship can, in one example, be one-way and established using a security token to prevent a service provider from having access other content items stored in the user's account. Accordingly, the user account can be synchronized across each of the user's devices, enabling the user to conveniently access their digital content subscription items from any of their devices.

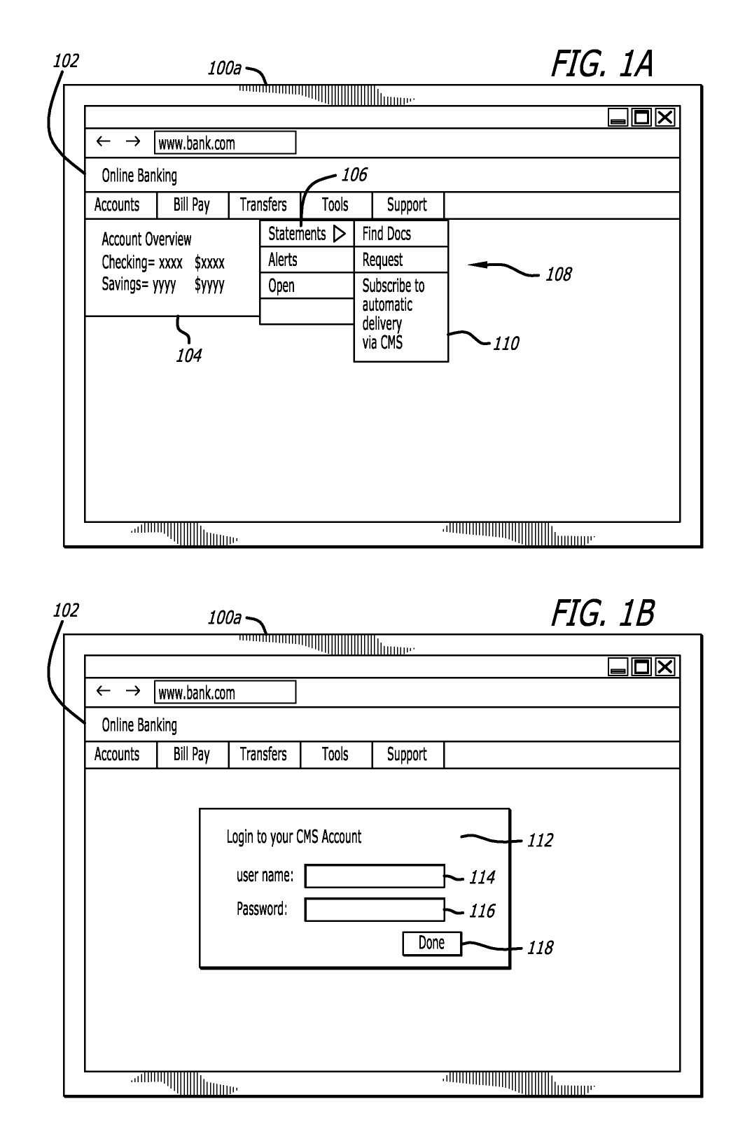

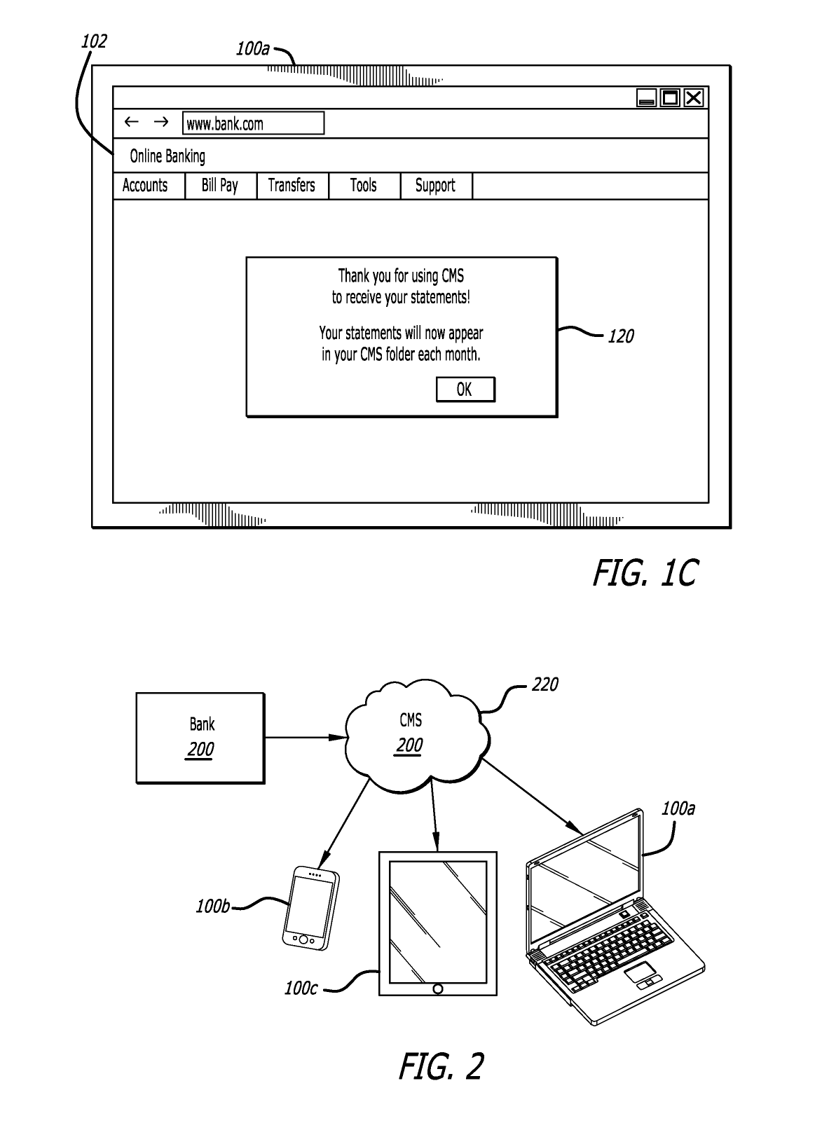

FIGS. 1A-1C show an example process where a user automatically receives content items from a service provider to an account at a synchronized content management system (CMS) in accordance with various embodiments. Accordingly, FIG. 1A shows an example screenshot of computing device 100a where a user selects the CMS to automatically receive and store content items periodically delivered by a third-party service provider (service provider). In this example, the service provider is a bank and the user is checking bank account information 104 (e.g., account balances, payment due dates, etc.) through online banking webpage 102. In this example, the user has selected statements 106 to open drop down menu 108, which includes various options associated with viewing and receiving bank statements including an option to have their bank statements automatically sent to a folder in their account with the CMS by selecting ‘Subscribe to automatic delivery via CMS’ 110.

FIG. 1B shows another example screenshot where the user logs into their account with the CMS to enable automatic content item delivery in accordance with at least one embodiment. Accordingly, the user has, in this example, chosen to receive their bank statements automatically via the CMS and has selected ‘Subscribe to automatic delivery via CMS’ 110, therefore, causing prompt 112 to be displayed to the user. In this example, prompt 112 is provided through online banking webpage 102 to enable the user to link the bank with the CMS by logging into their account at the CMS. In one example, the user is able to login to their account at the CMS without being navigated away from online banking webpage 102 through an application programming interface (API) provided by the CMS.

FIG. 1C shows another example screenshot where the service provider displays a confirmation message acknowledging future delivery of the content items to the CMS in accordance with at least one embodiment. Accordingly, once the user provides username 114 and password 116 to prompt 112 to sign into their account with the CMS and selects ‘Done’ 118, the user has established the persistent relationship between the bank and the CMS for them to receive their bank statements automatically in a folder of their account with the CMS. In response, online banking webpage 102 displays thank you message 120 acknowledging receipt of the user's intent to use the CMS to receive their bank statements and thanking the user for choosing to use the CMS for this service.

In order to establish the persistent relationship or link with a service provider that continues to periodically delivery content items to a user account, the CMS can generate and provide the service provider with a security token, which is provided to authenticate the service providers identity with the CMS. For example, the CMS could generate and issue an OATH token, which is a free and open-source software token that can be provided for two-factor authentication. Accordingly, any other security method that can enable a persistent or continued one-way link between a first entity and a second entity where the first entity can send content to the second entity without the first entity being able to access content stored with the second entity can also be used within the scope of various embodiments.

FIG. 2 shows an example environment where a service provider sends a content item to multiple computing devices associated with the user though the content management system in accordance with at least one embodiment. After the link has been established, bank 200 can send a content item to CMS 250 through network 220. Once CMS 250 receives the content item, CMS 210 can provide a copy of the content item to each computing device (100a, 100b, 100c) associated with the user's account. For example, computing device 100a could be a desktop computer that includes a client-side application that communicates with CMS 210 to synchronize a copy of a content item stored locally on each computing device (100a, 100b, 100c) with copy of the content item stored with CMS 250. In this example, the client-side application could include a folder containing each of a user's content items that is synchronized with CMS 250 when a new content item is inserted into the folder or an existing content item is modified. Thus, when bank 200 delivers a content item, CMS 250 will synchronize content in a folder associated with the user's account locally on each computing device (100a, 100b, 100c).

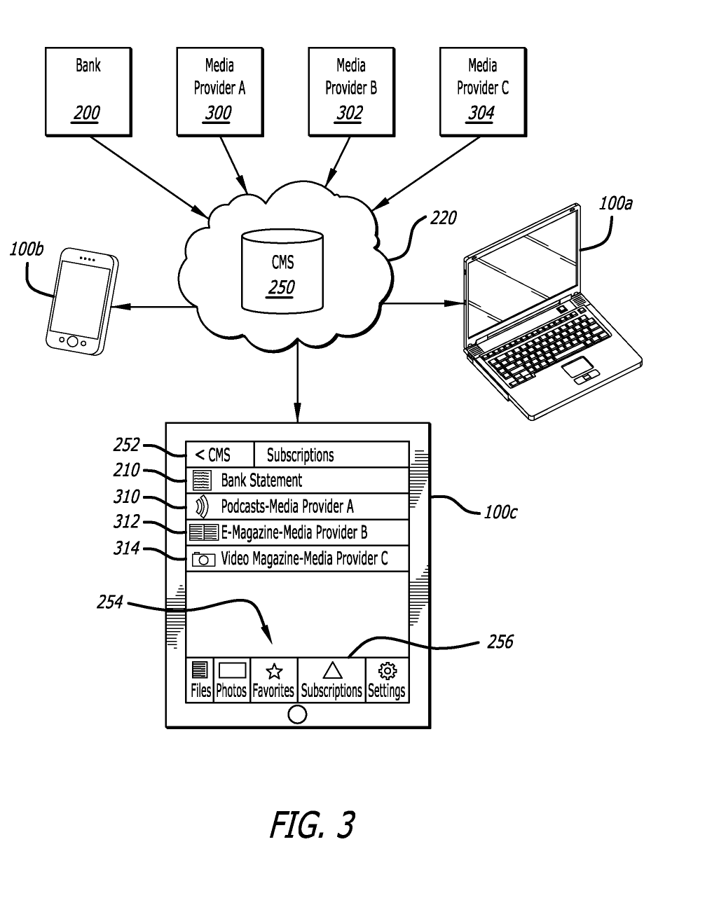

FIG. 3 shows another example environment where multiple service providers (200, 300, 302, 304) are able to send content items to multiple computing devices (100a, 100b, 100c) associated with the user though CMS 250 in accordance with at least one embodiment. In this example, the user has subscribed to receive content items from multiple service providers (200, 300, 302, 304) which include bank 200, Media Provider A 300, Media Provider B 302, and Media Provider C 304. In this example, the user has subscribed to bank 200 to receive their bank statements, Media Provider A 300 to receive Podcasts, Media Provider B 302 to receive E-Magazines, and Media Provider C 304 to receive videos. Accordingly, the user is able to receive various types of content from various types of service providers.

Further, shown in FIG. 3, is screenshot 254 of computing device 100c showing a screenshot of the user's subscriptions folder stored with CMS 250 in accordance with at least one embodiment. In this example, all of the subscription content that the user has subscribed to receive via CMS 250 could appear in subscriptions folder 256. Subscriptions folder 256, in this example, includes individual folders (210, 310, 312, 314) each corresponding to one of service providers (200, 300, 302, 304). Accordingly, the user can select bank statement folder 210 to view their bank statements, Media Provider A folder 310 to listen to their Podcasts, Media Provider B folder 312 to view their E-Magazines, and Media Provider C folder 314 to watch their videos. Thus, the user of computing devices (100a, 100b, 100c) can subscribe to receive content from multiple service providers (200, 300, 302, 304) and automatically receive and have the content stored in a single location accessible by a computing device without taking up unnecessary space of the computing device. Further, the user can also navigate back to a homepage of CMS 250 by selecting navigation button 252 or the user could access items the user has flagged as favorites by selecting ‘favorites’ button 254.

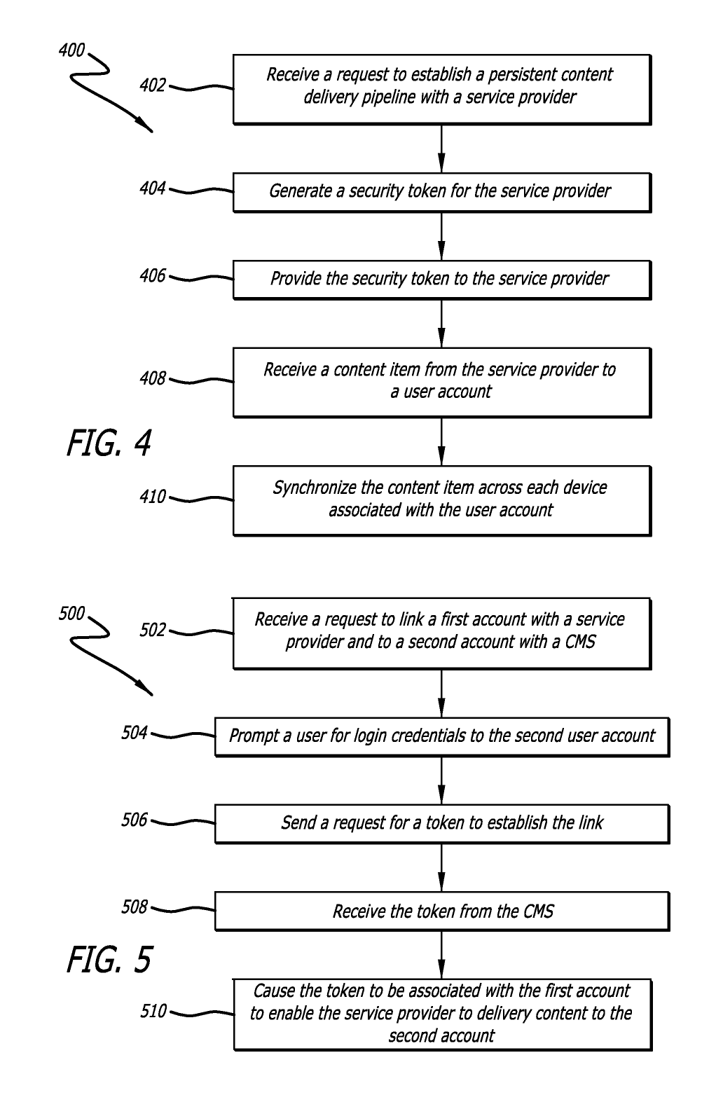

FIG. 4 shows an exemplary process 400 where a content management system (CMS) is selected to receive subscription content for a user in accordance with at least one embodiment. It should be understood that, for this and other processes discussed herein, there can be additional, fewer, or alternative steps, performed in similar or alternative orders, or in parallel, within the scope of the various embodiments unless otherwise stated. In this example, the CMS receives a request to establish a persistent content delivery pipeline with a service provider 402. The request, in this example, is from a user and the persistent content delivery pipeline is established for purposes of enabling the service provider to automatically deliver content to a folder associated with the user's account at the CMS.

In order to enable automatic delivery of the content items to the user's account, the CMS can generate a security token (e.g., an OATH token, etc.) for the service provider 404. Accordingly, the security token is provided to the service provider to authenticate the service provider's identity with the CMS 406. Once the persistent content delivery pipeline is established, the CMS can receive content item from the service provider on behalf of the user 408. For example, the CMS can receive a request from the service provider to deliver a content item to the folder associated with the user account and, using the token provided in the request, the CMS can authenticate the service provider using information encoded in the token. The content item can be stored in a single location or folder associated with the user's account that can then be synchronized across each of the user's computing devices (e.g., smartphone, tablet computer, desktop computer, etc.) associated with the user' account 410.

FIG. 5 shows another exemplary process 500 where a content management system (CMS) is selected to receive subscription content for a user in accordance with at least one embodiment. In one example, the user is able to login to their account at the CMS a webpage of a service provider through an API provided by the CMS. A first request from the user is received through the API to link an account that the user has with a service provider and to their account with the CMS 502. In response to the first request, the user can be prompted for their login credentials to their account with the CMS 504. Accordingly, a second request including the user's login credentials can be sent through the API for a security token to establish the link between the service provider and their account with the CMS 506. After the CMS has generated the security token, the token can be received by the service provider through the API 508 and associated with the user's account with the service provider to enable the service provider to delivery content to the user's account with the CMS 510.

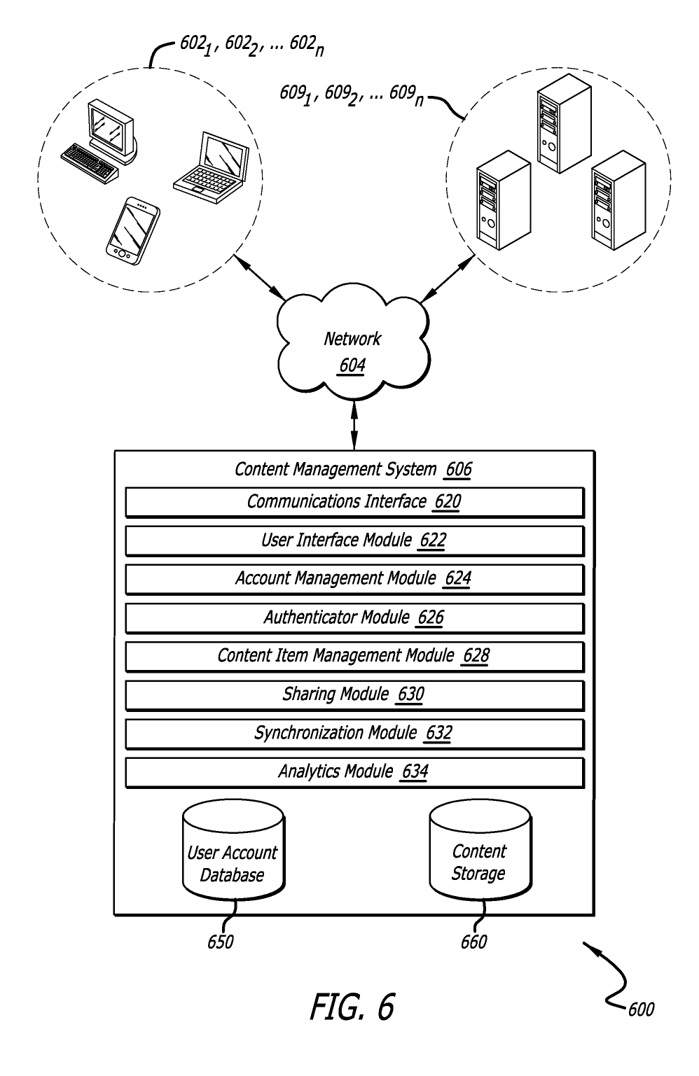

An exemplary system configuration 600 for enabling access to content of a compressed content item from a variety of computing devices is shown in FIG. 6, wherein computing devices communicate via a network for purposes of exchanging content and other data. The system can be configured for use on a wide area network such as that illustrated in FIG. 6. However, the present principles are applicable to a wide variety of network configurations that facilitate the intercommunication of electronic devices. For example, each of the components of system 600 in FIG. 6 can be implemented in a localized or distributed fashion in a network.

In system 600, a user can interact with content management system 606 through computing devices 602₁, 602₂, . . . , 602ₙ (collectively “602”) connected to network 604 by direct and/or indirect communication. Content management system 606 can support connections from a variety of different computing devices, such as desktop computers; mobile computers; mobile communications devices, e.g. mobile phones, smart phones, tablets; smart televisions; set-top boxes; and/or any other network enabled computing devices. Computing devices 602 can be of varying type, capabilities, operating systems, etc. Furthermore, content management system 606 can concurrently accept connections from and interact with multiple computing devices 602.

A user can interact with content management system 606 via a client-side application installed on computing device 602ᵢ. In some embodiments, the client-side application can include a content management system specific component. For example, the component can be a stand-alone application, one or more application plug-ins, and/or a browser extension. However, the user can also interact with content management system 606 via a third-party application, such as a web browser, that resides on computing device 602ᵢ and is configured to communicate with content management system 606. In either case, the client-side application can present a user interface (UI) for the user to interact with content management system 606. For example, the user can interact with the content management system 606 via a client-side application integrated with the file system or via a webpage displayed using a web browser application.

Content management system 606 can make it possible for a user to store content, as well as perform a variety of content management tasks, such as retrieve, modify, browse, and/or share the content. Furthermore, content management system 606 can make it possible for a user to access the content from multiple computing devices 602. For example, computing device 602ᵢ can upload content to content management system 606 via network 604. The content can later be retrieved from content management system 606 using the same computing device 602ᵢ or some other computing device 602ⱼ.

To facilitate the various content management services, a user can create an account with content management system 606. The account information can be maintained in user account database 650. User account database 650 can store profile information for registered users. In some cases, the only personal information in the user profile can be a username and/or email address. However, content management system 606 can also be configured to accept additional user information.

User account database 650 can also include account management information, such as account type, e.g. free or paid; usage information, e.g. file edit history; maximum storage space authorized; storage space used; content storage locations; security settings; personal configuration settings; content sharing data; etc. Account management module 624 can be configured to update and/or obtain user account details in user account database 650. The account management module 624 can be configured to interact with any number of other modules in content management system 606.

An account can be used to store content, such as digital data, documents, text files, audio files, video files, etc., from one or more computing devices 602 authorized on the account. The content can also include folders of various types with different behaviors, or other mechanisms of grouping content items together. For example, an account can include a public folder that is accessible to any user. The public folder can be assigned a web-accessible address. A link to the web-accessible address can be used to access the contents of the public folder. In another example, an account can include a photos folder that is intended for photos and that provides specific attributes and actions tailored for photos; an audio folder that provides the ability to play back audio files and perform other audio related actions; or other special purpose folders. An account can also include shared folders or group folders that are linked with and available to multiple user accounts. The permissions for multiple users may be different for a shared folder.

The content can be stored in content storage 660. Content storage 660 can be a storage device, multiple storage devices, or a server. Alternatively, content storage 660 can be a cloud storage provider or network storage accessible via one or more communications networks. Content management system 606 can hide the complexity and details from computing devices 602 so that computing devices 602 do not need to know exactly where the content items are being stored by content management system 606. In one variation, content management system 606 can store the content items in the same folder hierarchy as they appear on computing device 602ᵢ. However, content management system 606 can store the content items in its own order, arrangement, or hierarchy. Content management system 606 can store the content items in a network accessible storage (SAN) device, in a redundant array of inexpensive disks (RAID), etc. Content storage 660 can store content items using one or more partition types, such as FAT, FAT32, NTFS, EXT2, EXT3, EXT4, ReiserFS, BTRFS, and so forth.

Content storage 660 can also store metadata describing content items, content item types, and the relationship of content items to various accounts, folders, or groups. The metadata for a content item can be stored as part of the content item or can be stored separately. In one variation, each content item stored in content storage 660 can be assigned a system-wide unique identifier.

Content storage 660 can decrease the amount of storage space required by identifying duplicate files or duplicate segments of files. Instead of storing multiple copies, content storage 660 can store a single copy and then use a pointer or other mechanism to link the duplicates to the single copy. Similarly, content storage 660 can store files more efficiently, as well as provide the ability to undo operations, by using a file version control that tracks changes to files, different versions of files (including diverging version trees), and a change history. The change history can include a set of changes that, when applied to the original file version, produce the changed file version.

Content management system 606 can be configured to support automatic synchronization of content from one or more computing devices 602. The synchronization can be platform agnostic. That is, the content can be synchronized across multiple computing devices 602 of varying type, capabilities, operating systems, etc. For example, computing device 602ᵢ can include client software, which synchronizes, via a synchronization module 632 at content management system 606, content in computing device 602ᵢ's file system with the content in an associated user account. In some cases, the client software can synchronize any changes to content in a designated folder and its sub-folders, such as new, deleted, modified, copied, or moved files or folders. The client software can be a separate software application, can integrate with an existing content management application in the operating system, or some combination thereof. In one example of client software that integrates with an existing content management application, a user can manipulate content directly in a local folder, while a background process monitors the local folder for changes and synchronizes those changes to content management system 606. Conversely, the background process can identify content that has been updated at content management system 606 and synchronize those changes to the local folder. The client software can provide notifications of synchronization operations, and can provide indications of content statuses directly within the content management application. Sometimes computing device 602ᵢ may not have a network connection available. In this scenario, the client software can monitor the linked folder for file changes and queue those changes for later synchronization to content management system 606 when a network connection is available. Similarly, a user can manually stop or pause synchronization with content management system 606.

A user can also view or manipulate content via a web interface generated and served by user interface module 622. For example, the user can navigate in a web browser to a web address provided by content management system 606. Changes or updates to content in the content storage 660 made through the web interface, such as uploading a new version of a file, can be propagated back to other computing devices 602 associated with the user's account. For example, multiple computing devices 602, each with their own client software, can be associated with a single account and files in the account can be synchronized between each of the multiple computing devices 602.

Content management system 606 can include a communications interface 620 for interfacing with various computing devices 602, and can interact with other content and/or service providers 609₁, 609₂, . . . , 609ₙ (collectively “609”) via an Application Programming Interface (API). Certain software applications can access content storage 660 via an API on behalf of a user. For example, a software package, such as an app on a smartphone or tablet computing device, can programmatically make calls directly to content management system 606, when a user provides credentials, to read, write, create, delete, share, or otherwise manipulate content. Similarly, the API can allow users to access all or part of content storage 660 through a web site.

Content management system 606 can also include authenticator module 626, which can verify user credentials, security tokens, API calls, specific computing devices, and so forth, to ensure only authorized clients and users can access files. Further, content management system 606 can include analytics module 634 module that can track and report on aggregate file operations, user actions, network usage, total storage space used, as well as other technology, usage, or business metrics. A privacy and/or security policy can prevent unauthorized access to user data stored with content management system 606.

Content management system 606 can include sharing module 630 for managing sharing content publicly or privately. Sharing content publicly can include making the content item accessible from any computing device in network communication with content management system 606. Sharing content privately can include linking a content item in content storage 660 with two or more user accounts so that each user account has access to the content item. The sharing can be performed in a platform agnostic manner. That is, the content can be shared across multiple computing devices 602 of varying type, capabilities, operating systems, etc. The content can also be shared across varying types of user accounts.

In some embodiments, content management system 606 can include a content item management module 628 for maintaining a content directory. The content directory can identify the location of each content item in content storage 660. The content directory can include a unique content entry for each content item stored in the content storage.

A content entry can include a content path that can be used to identify the location of the content item in a content management system. For example, the content path can include the name of the content item and a folder hierarchy associated with the content item. For example, the content path can include a folder or path of folders in which the content item is placed as well as the name of the content item. Content management system 606 can use the content path to present the content items in the appropriate folder hierarchy.

A content entry can also include a content pointer that identifies the location of the content item in content storage 660. For example, the content pointer can include the exact storage address of the content item in memory. In some embodiments, the content pointer can point to multiple locations, each of which contains a portion of the content item.

In addition to a content path and content pointer, a content entry can also include a user account identifier that identifies the user account that has access to the content item. In some embodiments, multiple user account identifiers can be associated with a single content entry indicating that the content item has shared access by the multiple user accounts.

To share a content item privately, sharing module 630 can be configured to add a user account identifier to the content entry associated with the content item, thus granting the added user account access to the content item. Sharing module 630 can also be configured to remove user account identifiers from a content entry to restrict a user account's access to the content item.

To share content publicly, sharing module 630 can be configured to generate a custom network address, such as a uniform resource locator (URL), which allows any web browser to access the content in content management system 606 without any authentication. To accomplish this, sharing module 630 can be configured to include content identification data in the generated URL, which can later be used to properly identify and return the requested content item. For example, sharing module 630 can be configured to include the user account identifier and the content path in the generated URL. Upon selection of the URL, the content identification data included in the URL can be transmitted to content management system 606 which can use the received content identification data to identify the appropriate content entry and return the content item associated with the content entry.

In addition to generating the URL, sharing module 630 can also be configured to record that a URL to the content item has been created. In some embodiments, the content entry associated with a content item can include a URL flag indicating whether a URL to the content item has been created. For example, the URL flag can be a Boolean value initially set to 0 or false to indicate that a URL to the content item has not been created. Sharing module 630 can be configured to change the value of the flag to 6 or true after generating a URL to the content item.

In some embodiments, sharing module 630 can also be configured to deactivate a generated URL. For example, each content entry can also include a URL active flag indicating whether the content should be returned in response to a request from the generated URL. For example, sharing module 630 can be configured to only return a content item requested by a generated link if the URL active flag is set to 6 or true. Thus, access to a content item for which a URL has been generated can be easily restricted by changing the value of the URL active flag. This allows a user to restrict access to the shared content item without having to move the content item or delete the generated URL. Likewise, sharing module 630 can reactivate the URL by again changing the value of the URL active flag to 6 or true. A user can thus easily restore access to the content item without the need to generate a new URL.

While content management system 606 is presented with specific components, it should be understood by one skilled in the art, that the architectural configuration of system 606 is simply one possible configuration and that other configurations with more or less components are also possible.

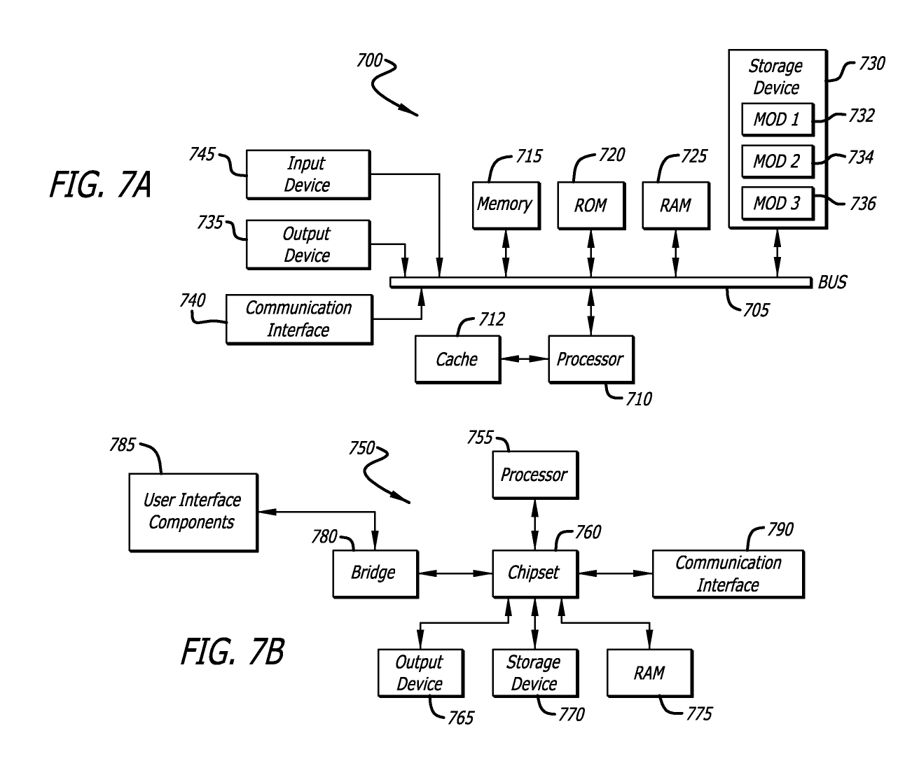

FIG. 7A, and FIG. 7B show exemplary possible system embodiments. The more appropriate embodiment will be apparent to those of ordinary skill in the art when practicing the present technology. Persons of ordinary skill in the art will also readily appreciate that other system embodiments are possible.

FIG. 7A shows a conventional system bus computing system architecture 700 wherein the components of the system are in electrical communication with each other using a bus 705. Exemplary system 700 includes a processing unit (CPU or processor) 710 and a system bus 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware module or software module, such as module 1 732, module 2 734, and module 3 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing device 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include software modules 732, 734, 736 for controlling the processor 710. Other hardware or software modules are contemplated. The storage device 730 can be connected to the system bus 705. In one aspect, a hardware module that performs a particular function can include the software component stored in a computer-readable medium in connection with the necessary hardware components, such as the processor 710, bus 705, display 735, and so forth, to carry out the function.

FIG. 7B shows a computer system 750 having a chipset architecture that can be used in executing the described method and generating and displaying a graphical user interface (GUI). Computer system 750 is an example of computer hardware, software, and firmware that can be used to implement the disclosed technology. System 750 can include a processor 755, representative of any number of physically and/or logically distinct resources capable of executing software, firmware, and hardware configured to perform identified computations. Processor 755 can communicate with a chipset 760 that can control input to and output from processor 755. In this example, chipset 760 outputs information to output 765, such as a display, and can read and write information to storage device 770, which can include magnetic media, and solid state media, for example. Chipset 760 can also read data from and write data to RAM 775. A bridge 780 for interfacing with a variety of user interface components 785 can be provided for interfacing with chipset 760. Such user interface components 785 can include a keyboard, a microphone, touch detection and processing circuitry, a pointing device, such as a mouse, and so on. In general, inputs to system 750 can come from any of a variety of sources, machine generated and/or human generated.

Chipset 760 can also interface with one or more communication interfaces 750 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 755 analyzing data stored in storage 770 or 775. Further, the machine can receive inputs from a user via user interface components 785 and execute appropriate functions, such as browsing functions by interpreting these inputs using processor 755.

It can be appreciated that exemplary systems 700 and 750 can have more than one processor 710 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-implemented method, comprising:
receiving, by a content management system (CMS), a request to establish a persistent one-way content delivery pipeline with a third-party service provider from a computing device associated with a user account at the CMS;
generating, by the CMS, a token for the third-party service provider, the token enabling the third-party service provider to push content to a folder associated with the user account; and
providing, by the CMS, the token to the third-party service provider.

2. The computer-implemented method of claim 1, further comprising:
causing a prompt to be displayed to the user to sign into the user account, the prompt including one or more fields for a username and a password.

3. The computer-implemented method of claim 2, wherein the prompt is provided through a webpage of the service provider and the user is able to login to the user account with the CMS through an application programming interface (API).

4. The computer-implemented method of claim 2, further comprising:
receiving, from the third-party service provider, a request to deliver a content item to the folder associated with the user account, the request including the token;
authenticating the third-party service provider for the user account based at least in part on information encoded in the token;
receiving the content item from the third-party service provider; and
causing the content item to be accessible to a user of the user account in the folder.

5. The computer-implemented method of claim 1, further comprising:
receiving, from the third-party service provider, a content item to the folder associated with the user account.

6. The computer-implemented method of claim 5, further comprising:
synchronizing the content item with a second computing device associated with the user account, wherein synchronizing the content item with the second computing device includes locally storing a copy of the content item in a corresponding folder associated with the user account on the second computing device.

7. The computer-implemented method of claim 6, wherein the CMS enables at least one of storing or modifying content from the computing device and the second computing device, each computing device locally storing the copy of the content item and communicating with the CMS to maintain copies of the content locally stored on each computing device.

8. A computing system, comprising:
at least one processor; and
memory including instructions that, when executed by the at least one processor, cause the computing system to:
receive, from a computing device, a request to establish a persistent delivery link between a service provider and the computing system, the computing device being associated with a user account at the computing system;
generate a token for the service provider, the token enabling the service provider to deliver content to the user account; and
provide the token to the service provider.

9. The computing system of claim 8, wherein the instructions that, when executed by the processor, further cause the computing system to:
receive, from the provider, a content item to a folder associated with the user account.

10. The computing system of claim 8, wherein the instructions that, when executed by the processor, further cause the computing system to:
receive, from the service provider, a request to deliver a content item to a folder associated with the user account, the request including the token;
authenticate the service provider for the user account based at least in part on information encoded in the token;
receive the content item from the service provider; and
cause the content item to be accessible in the folder of the user account.

11. The computing system of claim 10, wherein the instructions that, when executed by the processor, further cause the computing system to:
cause a prompt to be displayed to the user to sign into the user account, the prompt including one or more fields for a username and a password.

12. The computing system of claim 11, wherein the prompt is provided through a webpage of the service provider and the user is able to login to the user account with the computing system through an application programming interface (API).

13. The computing system of claim 11, wherein the request includes information associated with the service provider and the username and the password for the user account.

14. The computing system of claim 9, wherein the content item is at least one of a video, a document, an image, or an audio file.

15. The computing system of claim 9, wherein the instructions that, when executed by the processor, further cause the computing system to:
synchronizing the content item with a second computing device associated with the user account, wherein synchronizing the content item with the second computing device includes locally storing a copy of the content item in a corresponding folder associated with the user account on the second computing device.

16. The computing system of claim 15, wherein the computing system enables at least one of storing or modifying content from the computing device and the second computing device, each computing device locally storing the copy of the content item and communicating with the computing system to maintain copies of the content locally stored on each computing device.

17. A non-transitory computer-readable storage medium storing instructions that, when executed by at least one processor, cause a computing device to:
receive, from a user through a webpage of a service provider, a request to establish a link between a first user account with the service provider and a content management system (CMS), the link enabling the service provider to deliver content associated with the first user account to a second user account at the CMS;
prompt, from the webpage, the user for login credentials to the second user account with the CMS;
send, with the login credentials, a request for a security token to establish the link;
receive, from the CMS, the token; and
cause the security token to be associated with the first user account to enable the service provider to delivery content to the second user account.

18. The non-transitory computer-readable storage medium of claim 17, wherein the prompt is provided through a webpage of the service provider and the user is able to login to the user account with the CMS through an application programming interface (API).

19. The non-transitory computer-readable storage medium of claim 17, wherein the CMS enables at least one of storing or modifying content from the computing device and the second computing device, each computing device locally storing a copy of the content and communicating with the CMS to maintain copies of the content locally stored on each computing device.

20. The non-transitory computer-readable storage medium of claim 19, wherein the content is at least one of a video, a document, an image, or an audio file.
